(19) United States
(12) Patent Application Publication
(10) Pub. No.: US 2019/0099772 A1
(43) Pub. Date: Apr. 4, 2019

(54) WATERING WAND WITH ROTATABLE LEGS

(71) Applicant: Vincent Cella, Medford, NJ (US)

(72) Inventor: Vincent Cella, Medford, NJ (US)

(21) Appl. No.: 16/145,694

(22) Filed: Sep. 28, 2018

Related U.S. Application Data
(60) Provisional application No. 62/565,229, filed on Sep. 29, 2017.

(51) Int. Cl. B05B 15/625

(52) U.S. Cl. CPC B05B 15/625

(57) ABSTRACT

A water wand having an integral, elongated wand body having a forward nozzle section and a straight rear section extending rearward at an angle from and merging smoothly the nozzle section. A pair of elongated legs is rotatably mounted to the rear section of the wand body. The rotatable legs can be positioned parallel with and adjacent to the wand body for common hand-held watering, or they can be adjusted to set the wand on the ground at various stationary angles. This allows water flow dispersal at a multitude of different elevations and angles, while freeing the user from holding the wand during watering. The distal ends of the legs of the water wand are sharp and spike-like, which allows the legs to be inserted into the ground, thus increasing the stability of the wand when it is set at an angle.

### RELATED APPLICATION

This application claims the benefit of provisional application No. 62/565,229, filed on Sep. 29, 2017.

### BACKGROUND OF THE INVENTION

Water wands are commonly used to hydrate bushes, flowers, gardens and other plant life which are not easily reached or are not located in an area where water sprinklers are available. These wands are manually operated. That this, the user must hold and maintain the wand for a period of time, while directing the flow of water from the wand over the area which is being watered. There is currently no effective means of relieving the wand user from continuously holding and maintaining the wand while watering a particular garden or plant. Such a means would be genuine improvement in the use of water wands.

### SUMMARY OF THE INVENTION

The present invention provides this improvement in the form of a unique water wand which comprises an integral, elongated wand body having a forward nozzle section and a straight rear section extending rearward at an angle from and merging smoothly into the nozzle section. A pair of elongated legs is rotatably mounted to the rear section of the wand body. The rotatable legs can be positioned parallel with and adjacent to the wand body for common hand-held. watering, or the legs which can be adjusted to set the wand on the ground at various stationary angles. This allows the wand to disperse its flow of water at a multitude of different elevations and angles, while freeing the user from holding the wand during watering. The distal ends of the legs of the water wand are sharp and spike-like, which allows the legs to be inserted into the ground, thus increasing the stability of the wand When it is set at an angle.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 shows elevation, top, and front isometric views of the water wand of the present invention with its rotatable legs positioned alongside the body of the wand for hand-held use.

FIG. 2 shows elevation, front, and isometric views of the water wand of the present invention with its legs set at an acute angle in relation to the rear section of the wand body for placement on the ground surface.

FIG. 3 shows elevation, front, and isometric views of the water wand of the present invention with its legs set at an approximate 90° angle to the rear section of the wand body for placement on the ground surface.

### DETAILED DESCRIPTION OF THE INVENTION

Water wand 1 comprises integral, elongated wand body 2 having forward nozzle section 3 and straight rear section 4 which extends rearward at an angle from and merging smoothly into the nozzle section. Water nozzle 6 is located at the end of forward section 3 and handle 8 with an on and off switch 10 and water inlet 12 are located at the end of rear section 4. Water inlet 12 is rotatably attached adjacent to handle 8 at rotatable joint 14.

A pair of elongated legs 16 and 18 are rotatably attached at the upper end of rear section 4 by means of rotatable, universal joint mounts 20 and 22 which allow rotation both downward and outward. Legs 16 and 18 have sharp, spike like distal ends 17 and 19.

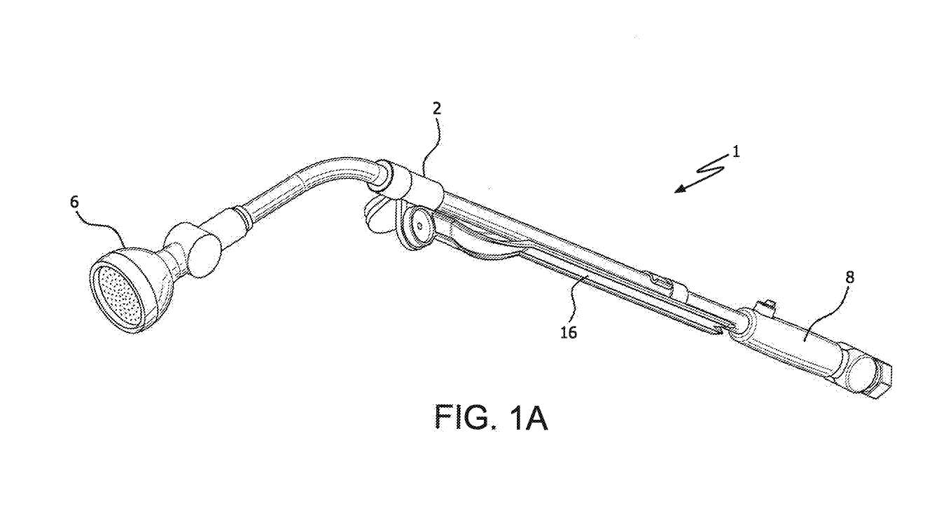

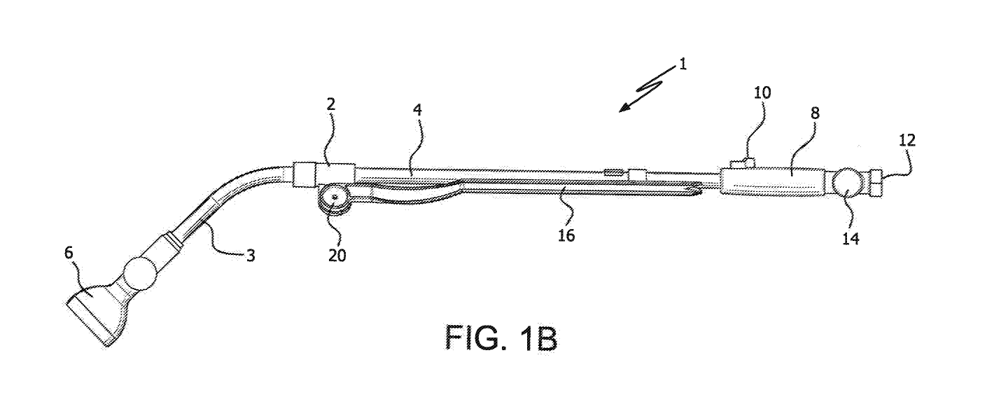

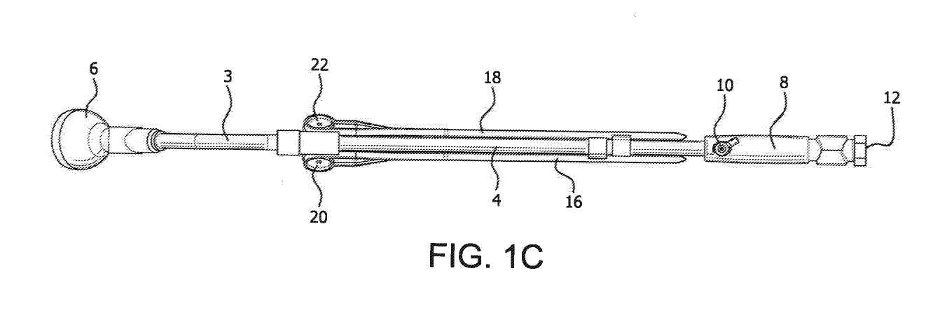

FIG. 1 illustrates wand 1 in a first, or hand-held position in which legs 16 and 18 are aligned parallel with, adjacent to, and alongside rear section 4. In this position, wand 1 can be used as a common, hand-held water wand.

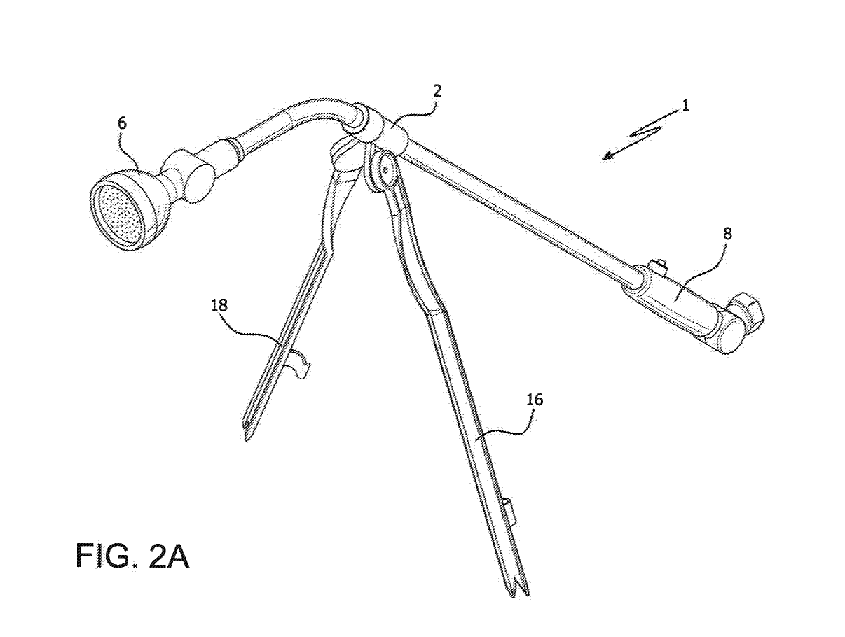

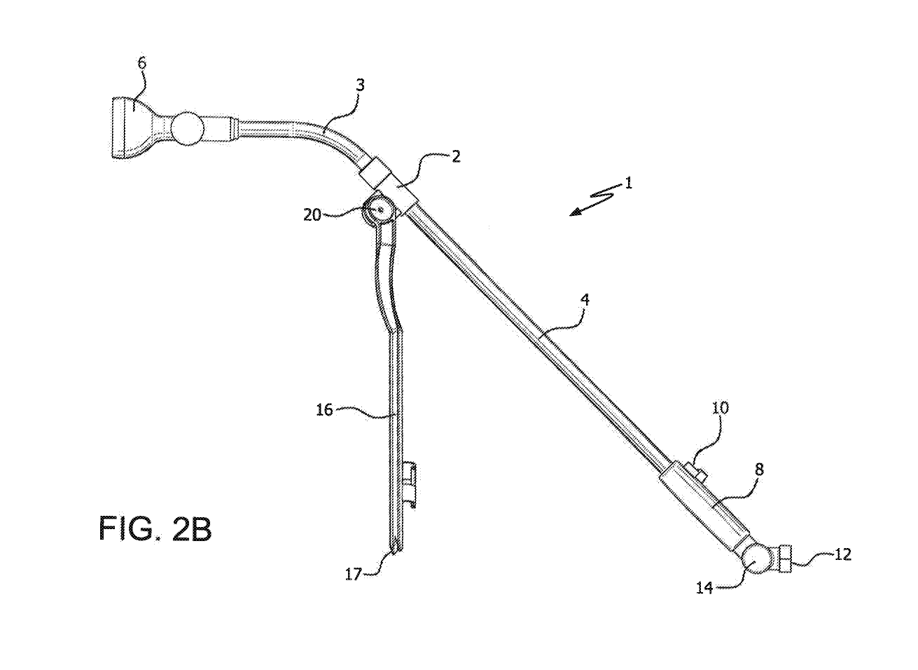

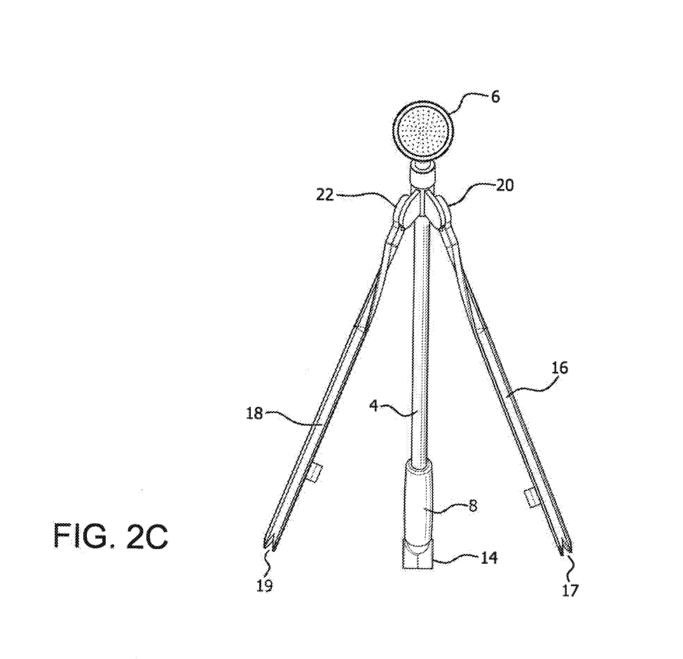

In a second position, shown in FIG. 2 and novel to the invention, legs 16 and 18 are rotated down from wand body 2 and spread outward, so that they are positioned at an acute angle in relation to rear section 4 and an acute angle in relation to each other. In this position, sharp distal ends 17 and 19 permit legs 16 and 18 to be driven into the ground in order to set wand 1 at any desired, hands-free angle.

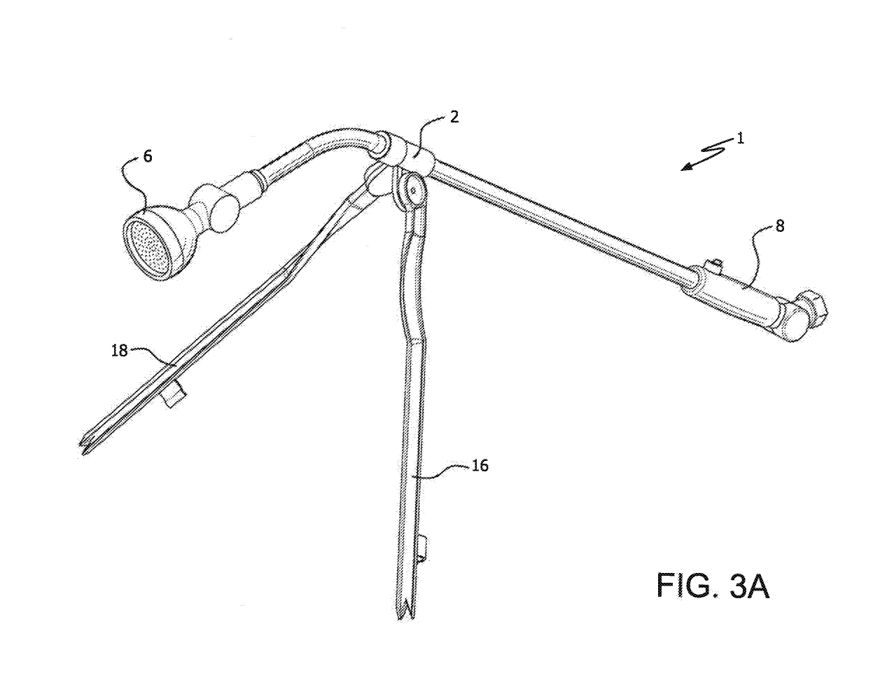

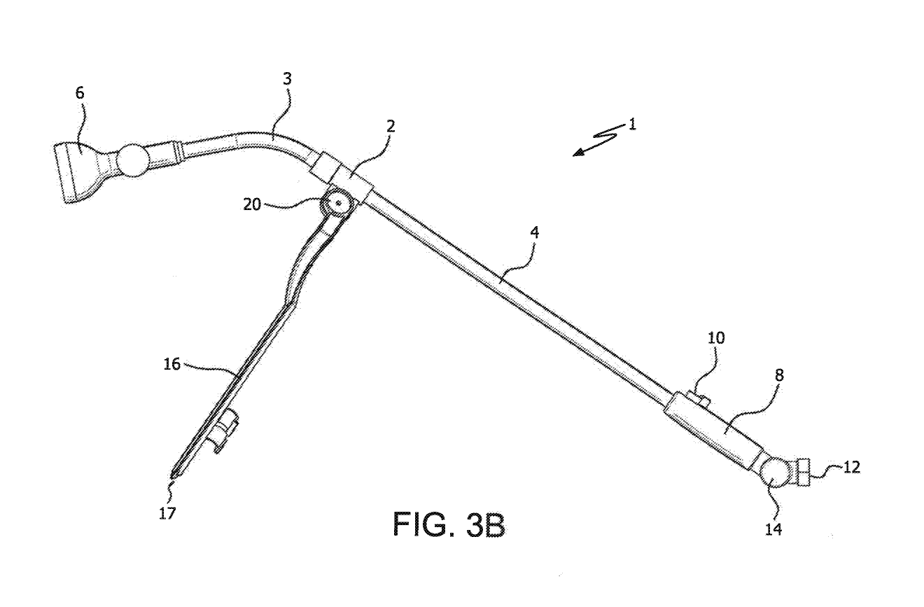

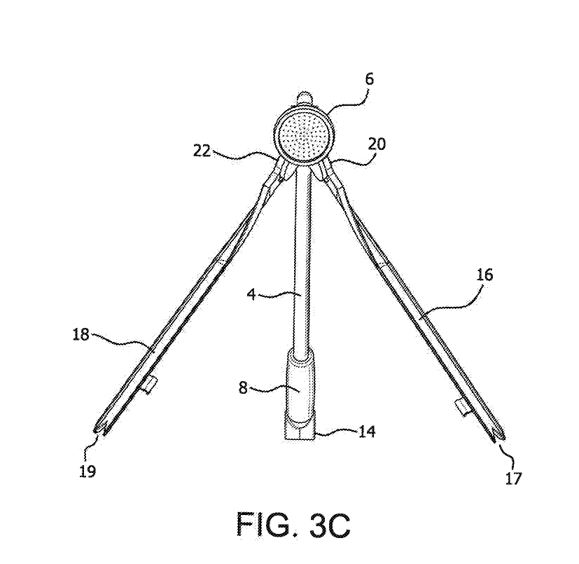

FIG. 3 shows the versatility of wand 1 by illustrating one of the many other angles in which the wand can be set. In this position legs 16 and 18 are rotated down from wand body 2 and positioned at a 90° angle in relation to rear section 4 and at an acute angle in relation to each other. This, in turn, angles water nozzle 6 down in order to water areas which are lower than those areas watered by the FIG. 2 positioning of wand 1.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A watering wand comprising:
an integral, elongated wand body, said wand body comprising a forward nozzle section having a water nozzle at its end and a straight rear section extending rearward at an angle from and merging smoothly into the nozzle section, said rear section having a handle at its end; and
a pair of elongated legs being rotatably mounted to the rear section of the wand body, whereby in a first position the pair of elongated legs are aligned parallel with and adjacent to the rear section and in a second position the elongated legs are extended down from the rear section at an acute angle in relation to the rear section, the elongated legs being configured to be rotatable from the first to the second position.

2. The watering wand as in claim 1 whereby in a third position, the elongated legs are set perpendicularly in relation to the wand body, the elongated legs being configured to be rotated from the first position to the third position.

3. The watering wand as in claim 1 wherein the elongated legs have sharp, spike-like distal ends.

4. A watering wand comprising:
an integral, elongated wand body, said wand body comprising a forward nozzle section having a water nozzle at its end and a straight rear section extending rearward at an angle from and merging smoothly into the nozzle section, said rear section having a handle at its end; and
a pair of elongated legs being rotatably mounted to the rear section of the wand body, the elongated legs being rotatably adjustable so as to extend both at acute angles in relation to the rear section of the wand body and perpendicularly in relation to the rear section of the wand body.

5. The watering wand as in claim 4 wherein the elongated legs have sharp, spike-like distal ends.
